(19) United States
(12) Patent Application Publication
(10) Pub. No.: US 2026/0246171 A1
(43) Pub. Date: Aug. 20, 2026

(54) Flexible Electric Connector for High Voltages With a Strand

(71) Applicant: Intercable Automotive Solutions GmbH, Bruneck (IT)

(72) Inventors: Florian Zimmerhofer, Percha (IT); Michael Ferdigg, St. Lorenzen (IT); Daniel Gutwenger, Innichen (IT)

(21) Appl. No.: 19/531,817

(22) Filed: Feb. 6, 2026

(30) Foreign Application Priority Data
Feb. 19, 2025 (EP) 25158927

(51) Int. Cl. H01R 11/12; H01R 4/06; H01R 11/01; H01R 43/02

(52) U.S. Cl. CPC H01R 11/12; H01R 4/06; H01R 11/01; H01R 43/0214

(57) ABSTRACT

A flexible electric connector is configured to handle a high voltage. The flexible electric connector includes a strand and a hollow rivet. The strand includes two contact strand sections and a flexible strand section. The two contact strand sections are configured to electrically connect the flexible electric connector to an external device. The flexible strand section electrically connects the two contact strand sections. At least one of the two contact strand sections defines a compacted contact strand section defining an opening. The compacted contact strand section is a section where at least one of the two contact strand sections is compacted. The hollow rivet extends through the opening and defines a through-hole configured to receive a connecting element.

### CROSS-REFERENCE TO RELATED APPLICATIONS

This application claims priority to EP 25 158 927 filed Feb. 19, 2025, the entire disclosure of which is incorporated herein by reference.

### FIELD

The present disclosure relates generally to electrical connectors, and more specifically to a flexible electric connector designed to provide reliable electrical conduction in environments where movement, misalignment, or vibrations may occur. In particular, the present disclosure pertains to applications that require the transmission of electrical power between components in systems that experience mechanical flexibility or vibration, such as in automotive, aerospace, and industrial equipment where high voltages may be of particular interest.

### BACKGROUND

Conventional electrical connectors, especially those used in systems subject to motion, vibrations, or thermal expansion, often suffer from mechanical stress, wear, or loss of electrical continuity. These connectors typically lack the ability to adapt to changes in relative positions or orientations of connected components without compromising signal integrity or performance or are difficult to mount in applications with little space. Existing flexible connectors, while addressing some mechanical flexibility, may not offer the desired durability, electrical conductivity, or versatility.

Thus, there exists a need for an improved flexible electric connector that can maintain electrical contact even when subjected to dynamic conditions, in particular vibrations, while also being robust enough to withstand environmental factors such as temperature fluctuations and requiring little space.

The technical task, therefore, is to provide an improved electrical connector with enhanced flexibility and conductivity, thereby ensuring reliable electrical connections in demanding applications with limited available space.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

This task is solved by the objects of the independent claims. Advantageous embodiments will be apparent from the dependent claims, the description and the figures.

One aspect relates to a flexible electric connector with a strand, the flexible electric connector being designed for high voltages. Therein, a voltage of more than 60V, preferably at least 100V, and/or less than 1000V, preferably maximally 800V, may be considered as high voltage. A strand may be or comprise a number of individual wires that are in electrical contact with each other, or a stranded wire. The individual wires may be twisted around each other, or not. Thus, the stranded wire may be braided and/or woven, or not. The strand may be made of or with a metal, such as copper, for instance.

The strand comprises at least two contact strand sections for electrically connecting the electric connector and a flexible strand section electrically connecting the two contact sections. The contact sections may be adjacent to the flexible strand section. Thus, the flexible strand section is allowing a relative movement of the two contact strand sections with respect to each other. At least one of the contact strand sections is configured for being electrically connected to an another (external) device via a connecting element. Therein, the strand is compacted in at least one contact strand section referred to as compacted contact strand section, which compacted contact strand section comprises a through-hole for the connecting element. The connecting element usually is an external connecting element, i.e. a connecting element not being part of the electric connector, such as a screw. In one or more of the at least one other contact strand section the strand may also be compacted. So the features and embodiments described in the following for the compacted contact strand section may correspond to more than one contact strand sections of the flexible electric connector. In particular, two contact strand sections may be compacted, and two contact strand sections are then penetrated by a respective hollow rivet providing the respective through-holes.

A hollow rivet extends through (is configured to pass through, i.e. penetrates) the compacted contact strand section and comprises or provides the through-hole for the connecting element. Thus, the rivet may constitute the through-hole through which the external connecting element is inserted to fix the flexible electric connector to another device.

This gives the advantage that reliability of the electric conductivity is increased while space required for the contact section of the connector is reduced. Namely, long-term evaluations have shown that known flexible strand connectors without rivet, where a screw is fixing the flexible strand connectors to another device via a through-hole directly in a compacted contact strand section, lead to decreased electric conductivity. It has been found out that this is due to the setting behavior of the fixation where the compacted strand is, in the long term, further compressed. This setting behavior leads to a decrease of pressure between connecting element, electric connector, and the other (external) device, thus an increase of resistance, at the site of the electrical contact between electric connector and the other device. The known alternative approaches, where such a setting behavior is avoided, rely on either contact sections of solid metal welded to compacted strand sections of the flexible electric connector, or cable lugs of one sort or another that are crimped over the cable. These alternative approaches, though, for a given overall length of the connector, lead to a loss of flexibility since respective contact/end sections are not flexible anymore—those non-flexible end sections cover a significant part of the length of the connector, mostly also increasing its thickness and thus usually require more space. Consequently, the approach presented here results, by use of the hollow rivet, in both increased long-term conductivity, i.e. increased reliability, and increased flexibility, i.e. increased versatility in particular with respect to applications with little available space. In particular, a long-term quality factor k defined e.g. by k=resistance(connection)/resistance(material) of k<1.5 may be achieved. The resistance of the connection may be measured over an overlap length, and the resistance of the material, i.e. here the strand, over a length of the same size. Therein, advantageously, the compacted contact strand section does not need to comprise a cable lug or alike, i.e. there need not be a cable lug or the like at the compacted strand section.

Consequently, it may be provided that in the compacted contact strand section, the compacted strand surrounds a cylindrical hollow part the hollow rivet, where in particular the compacted strand is in mechanical contact (and thus direct electrical contact) with the cylindrical hollow part and/or the compacted strand is in mechanical contact (and thus direct electrical contact) with one or two flanges of the hollow rivet. This decreases the electrical resistance/improves conductivity.

It may be provided that the hollow rivet is welded with the compacted strand of the compacted contact strand section, in particular resistance-welded. In addition, or alternative, to resistance-welding, also diffusion-welding may be used. This is particularly advantageous in combination with the features of the last paragraph and further improves conductivity and reliability.

The hollow rivet may be coated for better conductance, in particular be a coated copper rivet. This is particularly advantageous in combination with the features of the last paragraph, since it has been found out that, due to the relatively large area of contact between rivet and compacted strand, the hollow rivet can be welded, in particular resistance-welded, with the compacted strand without relevant damage to the coating. Hence, thus further improves conductivity and reliability.

In some implementations, it may be provided that the strand is or comprises, at least in the flexible strand section, a braided strand. This gives the advantage of increased durability, in particular of the compacted sections, thus increased reliability of the electric connection.

In some implementations, it may be provided that a length of the (respective) compacted contact strand section is less than 40%, preferably less than 35%, of the overall length of the flexible electric connector and/or more than 20%, preferably more than 25%, of the overall length of the flexible electric connector. This gives the advantage that the relative flexibility (i.e. flexibility per length) of the flexible electric connector is increased, which is particularly advantageous for short electric connectors as used in application with only little space available (compare next embodiment). Such high relative flexibility results in improved reliability due to enhanced robustness with respect to e.g. vibrations.

In some implementations, it may be provided that the overall length of the flexible electric connector is less than 10 cm, preferably less than 7 cm, more preferably less than 6.5 cm, and/or the length of the compacted contact strand section is less than 3 cm, preferably less than 2.5 cm, more preferably less than 2.2 cm. The conductor cross-section of the flexible strand section may be at least 25 mm2 and/or maximally 250 mm2. Here, for a relatively short flexible connector, the proposed approach is particularly advantageous. A very high relative flexibility can be achieved, in particular in combination with the features of the last paragraph.

In some implementations, it may be provided that a broadness of the flexible strand section is larger than the thickness of the flexible strand section, and/or a broadness of the compacted contact strand is larger than the thickness of the compacted contact strand. Therein, the broadness is measured perpendicular to the thickness, as well as perpendicular to a main extension direction of the flexible electric connector (when not bent, i.e. in a straight state). So the flexible strand section and/or the compacted contact strand section may have a rectangular or at least essentially rectangular cross-section. In particular, the ratio of broadness/thickness may be at least 1.5/1, preferably at least 2/1. This safes space and improves flexibility.

In some implementations, it may be provided that a thickness of the electric connector measured at a position of the hollow rivet in a through-direction of the through-hole is more than a thickness of the compacted contact strand section. The compacted strand section may extend from a start of the compacted section of the strand to an end of electric connector. This gives the advantage of reduced space requirements while maintaining high reliability.

Another aspect relates to method for manufacturing a flexible electric connector with a flexible strand, in particular a flexible electric connector according to one of the embodiments described above. This method comprises a number of method steps.

One method step comprises compacting the flexible strand in at least one contact section. There are various known methods for compacting: drawing the strand through a compacting die, roller reduction and rotary swaging are several examples. Another preferred method for compacting is with or by resistance welding. The compacting process flattens the surface of the outer wires and reforms internal wires of the strand to increase the metallic area of the strand in a cross-section relative to the overall area of the strand in the cross-section. As a next method step, a through-opening is punched into the compacted contact section.

Subsequent method steps comprise inserting a hollow rivet (that comprises a through-hole for a connecting element) into the through-opening and fixing the hollow rivet arranged in the through-opening. The hollow rivet then provides the through-hole for a connecting element Fixing the hollow rivet may be or comprise crimping and/or welding, in particular resistance-welding, the hollow rivet. Flanging the rivet protects the coating, and saves time (while not welding it to the compacted strand).

Advantages and advantageous embodiments of the latter aspects correspond to the advantages and advantageous embodiments described for the former aspect, and vice versa.

The features and combinations of features described, including those of the general introduction, as well as the features and combinations of features disclosed in the figure description or in the figures alone, may be used not only alone or in the combination described, but also with other features or without some of the features disclosed, without departing from the scope of the invention. Consequently, embodiments are also part of the invention which are not explicitly shown and described in the figures, but which can be produced by separately combining the individual features disclosed in the figures. Therefore, embodiments and combinations of features which do not comprise all features of an originally formulated independent claim are also to be considered disclosed. Furthermore, embodiments and combinations of features are to be regarded as disclosed which deviate from or go beyond the combinations of features described in the dependencies of the claims.

In the context of the present disclosure, “transverse/along” may be understood as “at least substantially perpendicular/parallel”, i.e. “perpendicular/parallel” or “substantially perpendicular/parallel”, i.e. perpendicular/parallel except for a predetermined deviation. The predetermined deviation can, for example, be at most 15°, preferably at most 5°, particularly preferably at most 3°. Accordingly, “oppositely oriented” may be understood in the context of the present disclosure as “at least substantially oppositely oriented” i.e. “at least substantially anti-parallel oriented”. The orientation of a plane may be determined by its normal vector. The limitation “substantially” may also refer to a percentage predetermined maximum permissible deviation, for example at most 15%, preferably at most 5%, particularly preferably at most 3%.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1A-1C illustrate an example method for manufacturing a flexible electric connector;

FIG. 2 shows a cross-section of an example of a flexible electric connector.

In the drawings, reference numbers may be reused to identify similar and/or identical elements.

### DETAILED DESCRIPTION

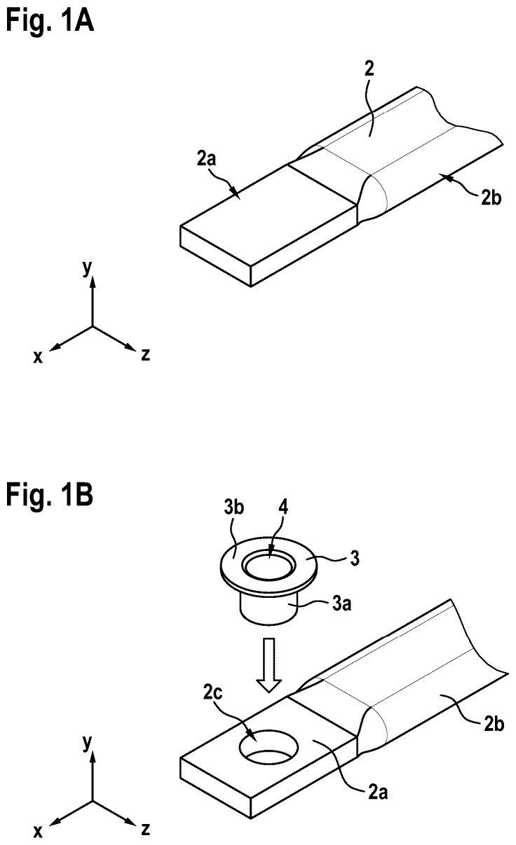

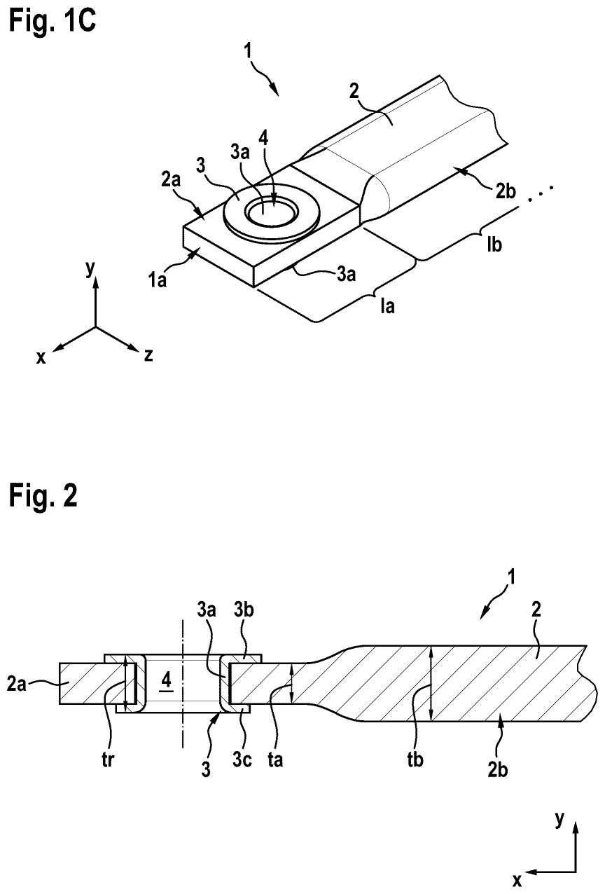

FIGS. 1A-1C are provided to illustrate an example method for manufacturing a flexible electric connector as shown e.g. in FIG. 2.

FIG. 1A shows a part of a flexible strand 2 with a contact strand section 2a located on one end of a flexible strand section 2b. Note that another contact strand section may be provided at another end of the strand 2, which is not shown but may be configured according to the shown contact strand section 2a. The flexible strand 2 is compacted in the contact strand section 2a in a preceding manufacturing step, and has an at least essentially rectangular cross-section here. Thus, in this example, a broadness (measured in the z-direction here) of the of the compacted contact strand section 2a is larger than a thickness (measured in the y-direction here) of the of the compacted contact strand section 2a. Preferably, as shown in this example, the thickness of the compacted contact strand section 2a is smaller than the thickness of the flexible strand section 2b.

FIG. 1B illustrates subsequent method steps where a through-opening 2c is punched into the compacted contact strand section 2a and a rivet 3 with a through-hole 4 is inserted into the through-opening 2c. Thereby, in the compacted contact strand section 2a, the compacted strand finally surrounds a cylindrical hollow part 3a the hollow rivet 3 and comes in direct mechanical (thus also electrical) contact with said cylindrical hollow part 3a here. In addition, the compacted strand comes in direct mechanical (thus also electrical) contact with a flange 3b.

After the inserting the hollow, the hollow rivet 3 placed in the through-opening 2c as shown in FIG. 1C and is fixed by flanging hollow rivet 3, possibly in combination with welding, in particular resistance-welding, the hollow rivet 3 with the compacted strand 2. Then, also another flange 3c (FIG. 2) comes in direct mechanical (thus also electrical) contact with the compacted strand. Here, a length la of the compacted contact strand section 2a is less than 35% of an overall length l of the flexible electric connector 1 measured from one end 1a to the opposite end (not shown) along a main extension direction of the flexible electric connector 1 in a straight state (x-direction here). The main extension direction of the the flexible electric connector 1 corresponds to the main extension direction of the flexible strand section 2b, and potentially also to the main extension direction of the contact strand section 2a. When two compacted contact strand section 2a are provided the overall length l may be l=la+lb+la, with lb being the length of the flexible strand section 2b.

FIG. 2 shows a cross-section of an example embodiment of a flexible electric connector as it may be manufactured following a method with the method steps described with reference to FIGS. 1A-1C. Thus, the features described there may also apply for the embodiment of FIG. 2, with some possible additional features described in the following.

In particular, in the shown example, a thickness tr (measured in y-direction here) of the flexible electric connector 1 measured at a position of the hollow rivet 3 is more than a thickness ta of the compacted contact strand section 2a. In the example provided here, it is also less than a thickness tb of the flexible strand section 2b, but generally, it may also be of comparable thickness or even greater thickness. This thickness tr of the electric connector 1 may correspond to a thickness of the hollow rivet 3 and preferably is smaller than a diameter of the hollow rivet 3. Thus, provided tb-tr is large enough, a connecting element, e.g. a head of a screw, may even be flat enough to not or not significantly protrude over the flexible electrical connector 1 in the y direction, which further saves space.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. In the written description and claims, one or more steps within a method may be executed in a different order (or concurrently) without altering the principles of the present disclosure. Unless indicated otherwise, numbering or other labeling of instructions or method steps is done for convenient reference, not to indicate a fixed order.

Numerical terms, such as “first,” “second,” and “third,” may be used in the disclosure and claims as unique labels: they are not used to imply a sequence or order unless the context clearly indicates otherwise. In other words, a “second” element could be relabeled as a “first” element without departing from the principles of the present disclosure. Further, the presence of a “second” element does not imply or require the presence of a “first” element. Similarly, the presence of a “first” element does not imply or require the presence of a “second” element.

Unless the context clearly indicates otherwise, the singular articles “a,” “an,” and “the” before a noun do not restrict the noun to a single instance. The verbs “comprise,” “include,” and “have” are inclusive and therefore specify the presence of elements without excluding the presence of one or more additional elements.

Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements are described using various terms, including “connected,” “coupled,” “engaged,” “adjacent,” “next to,” “on top of,” “above,” “below,” and “disposed.” Unless explicitly described as being “direct,” when a relationship between first and second elements is described in the above disclosure, that relationship encompasses a direct relationship where no other intervening elements are present between the first and second elements as well as an indirect relationship where one or more intervening elements are present between the first and second elements.

The term “set” generally means a grouping of one or more elements. The elements of a set do not necessarily need to have any characteristics in common or otherwise belong together. However, in various implementations a “set” may, in certain circumstances, be the empty set (in other words, the set has zero elements in those circumstances). As an example, a set of search results resulting from a query may, depending on the query, be the empty set. In contexts where it is not otherwise clear, the term “non-empty set” can be used to explicitly denote exclusion of the empty set —that is, a non-empty set will always have one or more elements.

A “subset” of a first set generally includes some of the elements of the first set. In various implementations, a subset of the first set is not necessarily a proper subset: in certain circumstances, the subset may be coextensive with (equal to) the first set (in other words, the subset may include the same elements as the first set). In contexts where it is not otherwise clear, the term “proper subset” can be used to explicitly denote that a subset of the first set must exclude at least one of the elements of the first set. Further, in various implementations, the term “subset” does not necessarily exclude the empty set. As an example, consider a set of candidates that was selected based on first criteria and a subset of the set of candidates that was selected based on second criteria; if no elements of the set of candidates met the second criteria, the subset may be the empty set. In contexts where it is not otherwise clear, the term “non-empty subset” can be used to explicitly denote exclusion of the empty set.

The phrase “at least one of A, B, and C” should be construed to mean a logical (A OR B OR C), using a non-exclusive logical OR, and should not be construed to mean “at least one of A, at least one of B, and at least one of C.” The phrase “at least one of A, B, or C” should be construed to mean a logical (A OR B OR C), using a non-exclusive logical OR. The phrase “A, B, and/or C” should be construed in the same way as the phrase “at least one of A, B, and C.”

The examples of the present disclosure may include one or more components such as connectors, terminals, conductors, insulating members, shielding structures, housings, retention features, and sealing elements, among others, as well as corresponding systems and assemblies. These examples may be configured to facilitate electrical signal transmission, power delivery, electromagnetic compatibility, or mechanical retention under various environmental conditions, such as thermal cycling, vibration, or exposure to fluids. Disclosed components, systems and assemblies, among others, may be arranged modularly or integrally to accommodate various system architectures and routing constraints.

Disclosed components may be fabricated from thermoplastics, thermoset resins, composites, or metals, optionally treated or coated for corrosion resistance, electromagnetic interference shielding, or biocompatibility for use in various applications, system, and environments, among others. In particular, in medical applications, sterilizable and/or biocompatible materials may be used. In solar or renewable energy systems, UV-resistant and/or weatherproof materials may be incorporated. In aerospace and space-based systems, weight reduction may be prioritized, and high-performance materials such as polyimide films, fluoropolymers, or ceramic composites may be employed.

Disclosed components, systems and assemblies, among others, may be designed for automated assembly, including robotic insertion, ultrasonic welding, or crimping techniques. Adaptations may be made to ensure compliance with relevant standards, including International Organization for Standardization, Military Specification, Society of Automotive Engineers, Food and Drug Administration, or International Electrotechnical Commission, depending on the target industry or market. In this regard, while examples and embodiments of the present disclosure may be illustrated and described herein in the context of an automobile, it will be appreciated that such examples and embodiments are equally suited for other applications, systems, environments, industries, and markets, among others. For example, implementations of the present disclosure that relate generally to electrical components and assemblies, and more particularly to connectors, terminals, wiring harnesses, and integrated electrical interconnection systems, among others, are suitable for a wide range of environments and applications.

While exemplary embodiments described herein may reference automotive use cases, the disclosed technology is not limited thereto and may be employed in any system requiring, for example, robust, secure, reliable, and/or durable electrical connectivity, among others. In particular, the structures, materials, and configurations disclosed may be adapted for use in aerospace systems, medical devices, consumer electronics, industrial automation, energy distribution networks, solar and other renewable energy installations, marine vessels, and space exploration platforms. Accordingly, although specific embodiments may describe automotive implementations, the principles disclosed herein are equally applicable to any system requiring robust electrical interconnection, and claims directed to any system, application, and/or environmental domain are, and will be, contemplated by one of skill in the art.

Various example embodiments of the invention are described in the following clauses.

Clause 1: A flexible electric connector configured to handle a high voltage, the flexible electric connector comprising: a strand including: two contact strand sections configured to electrically connect the flexible electric connector to an external device; and a flexible strand section electrically connecting the two contact strand sections, wherein: at least one of the two contact strand sections defines a compacted contact strand section defining an opening, and the compacted contact strand section is a section where at least one of the two contact strand sections is compacted; and a hollow rivet extending through the opening and defining a through-hole configured to receive a connecting element.

Clause 2: The flexible electric connector of clause 1 wherein: in the compacted contact strand section, the strand surrounds a cylindrical hollow part of the hollow rivet, and the strand is in mechanical contact with at least one of: the cylindrical hollow part or one or two flanges of the hollow rivet.

Clause 3: The flexible electric connector of any of clauses 1-2 wherein the compacted contact strand section does not include a cable lug.

Clause 4: The flexible electric connector of any of clauses 1-3 wherein the strand includes, at least in the flexible strand section, a braided strand.

Clause 5: The flexible electric connector of any of clauses 1-4 wherein a length of the compacted contact strand section is less than 40% and more than 20% of an overall length of the flexible electric connector.

Clause 6: The flexible electric connector of any of clauses 1-5 wherein at least one of: an overall length of the flexible electric connector is less than 10 cm, or a length of the compacted contact strand section is less than 3 cm.

Clause 7: The flexible electric connector of any of clauses 1-6 wherein the hollow rivet is a coated copper rivet.

Clause 8: The flexible electric connector of any of clauses 1-7 wherein the hollow rivet is at least one of: welded or resistance-welded to the compacted contact strand section.

Clause 9: The flexible electric connector of any of clauses 1-8 wherein a thickness of the flexible electric connector measured at a position of the hollow rivet in a through-direction of the through-hole is greater than a thickness of the compacted contact strand section.

Clause 10: The flexible electric connector of any of clauses 1-9 wherein a thickness of the hollow rivet is smaller than a diameter of the hollow rivet.

Clause 11: The flexible electric connector of any of clauses 1-10 wherein at least one of: a first broadness of the flexible strand section measured perpendicular to a thickness of the flexible strand section, as well as perpendicular to a main extension direction of the flexible strand section is larger than the thickness of the flexible strand section, or a second broadness of the compacted contact strand section measured perpendicular to a thickness of the compacted contact strand section, as well as perpendicular to a main extension direction of the compacted contact strand section is larger than the thickness of the compacted contact strand section.

Clause 12: The flexible electric connector of any of clauses 1-11 wherein the high voltage is a voltage of more than 60V and less than 1000V.

Clause 13: The flexible electric connector of any of clauses 1-12 wherein: both of the two contact strand sections are compacted, and both of the two contact strand sections are penetrated by a respective hollow rivet defining a respective through-hole.

Clause 14: A method of manufacturing a flexible electric connector with a flexible strand, the method comprising: compacting the flexible strand in at least one contact strand section of the flexible strand to form a compacted contact strand section; punching a through-opening into the compacted contact strand section; inserting a hollow rivet into the through-opening; and fixing the hollow rivet arranged in the through-opening.

Clause 15: The method of clause 14 wherein fixing the hollow rivet includes at least one of: flanging, welding, or resistance-welding the hollow rivet.

1. A flexible electric connector configured to handle a high voltage, the flexible electric connector comprising:
a strand including:
two contact strand sections configured to electrically connect the flexible electric connector to an external device; and
a flexible strand section electrically connecting the two contact strand sections, wherein:
at least one of the two contact strand sections defines a compacted contact strand section defining an opening, and
the compacted contact strand section is a section where at least one of the two contact strand sections is compacted; and
a hollow rivet extending through the opening and defining a through-hole configured to receive a connecting element.

2. The flexible electric connector of claim 1 wherein:
in the compacted contact strand section, the strand surrounds a cylindrical hollow part of the hollow rivet, and
the strand is in mechanical contact with at least one of: the cylindrical hollow part or one or two flanges of the hollow rivet.

3. The flexible electric connector of claim 1 wherein the compacted contact strand section does not include a cable lug.

4. The flexible electric connector of claim 1 wherein the strand includes, at least in the flexible strand section, a braided strand.

5. The flexible electric connector of claim 1 wherein a length of the compacted contact strand section is less than 40% and more than 20% of an overall length of the flexible electric connector.

6. The flexible electric connector of claim 1 wherein at least one of:
an overall length of the flexible electric connector is less than 10 cm, or
a length of the compacted contact strand section is less than 3 cm.

7. The flexible electric connector of claim 1 wherein the hollow rivet is a coated copper rivet.

8. The flexible electric connector of claim 1 wherein the hollow rivet is at least one of: welded or resistance-welded to the compacted contact strand section.

9. The flexible electric connector of claim 1 wherein a thickness of the flexible electric connector measured at a position of the hollow rivet in a through-direction of the through-hole is greater than a thickness of the compacted contact strand section.

10. The flexible electric connector of claim 1 wherein a thickness of the hollow rivet is smaller than a diameter of the hollow rivet.

11. The flexible electric connector of claim 1 wherein at least one of:
a first broadness of the flexible strand section measured perpendicular to a thickness of the flexible strand section, as well as perpendicular to a main extension direction of the flexible strand section is larger than the thickness of the flexible strand section, or
a second broadness of the compacted contact strand section measured perpendicular to a thickness of the compacted contact strand section, as well as perpendicular to a main extension direction of the compacted contact strand section is larger than the thickness of the compacted contact strand section.

12. The flexible electric connector of claim 1 wherein the high voltage is a voltage of more than 60V and less than 1000V.

13. The flexible electric connector of claim 1 wherein:
both of the two contact strand sections are compacted, and
both of the two contact strand sections are penetrated by a respective hollow rivet defining a respective through-hole.

14. A method of manufacturing a flexible electric connector with a flexible strand, the method comprising:
compacting the flexible strand in at least one contact strand section of the flexible strand to form a compacted contact strand section;
punching a through-opening into the compacted contact strand section;
inserting a hollow rivet into the through-opening; and
fixing the hollow rivet arranged in the through-opening.

15. The method of claim 14 wherein fixing the hollow rivet includes at least one of: flanging, welding, or resistance-welding the hollow rivet.
